(19) United States
(12) Patent Application Publication
(10) Pub. No.: US 2025/0307124 A1
(43) Pub. Date: Oct. 2, 2025

(54) VECTOR TEST ZONED INSTRUCTION FOR VALIDITY TESTING

(71) Applicant: INTERNATIONAL BUSINESS MACHINES CORPORATION, Armonk, NY (US)

(72) Inventors: Michael KLEIN, Schoenaich (DE); Kerstin Claudia SCHELM, Stuttgart (DE); Petra LEBER, Ehningen (DE); Andreas WAGNER, Wildberg (DE); Bruce Conrad GIAMEI, Lagrangeville, NY (US); Timothy SLEGEL, Staatsburg, NY (US); Jonathan D. BRADBURY, Poughkeepsie, NY (US); Reid COPELAND, Ontario (CA); Xin GUO, Toronto (CA)

(21) Appl. No.: 18/618,559

(22) Filed: Mar. 27, 2024

(51) Int. Cl. G06F 11/36; G06F 8/41

(52) U.S. Cl. CPC G06F 11/3688; G06F 8/437

(57) ABSTRACT

An instruction to perform validity testing of a source value is executed. The executing the instruction includes obtaining the source value using at least one field of the instruction and performing validity testing of at least a portion of the source value. The performing the validity testing is based on one or more test controls obtained using a field of the instruction. The performing the validity testing determines whether a format of the at least the portion of the source value adheres to a data format variation specified by, at least, the one or more test controls. The performing the validity testing provides a result, and the result is provided for use in further processing.

### BACKGROUND

One or more aspects relate, in general, to facilitating processing within a computing environment, and in particular, to improving processing within the computing environment.

Computer programs executing within a computing environment perform operations on data. The data may be in various data formats. Each format has one or more possible encodings, and if an encoding is not adhered to, the data is invalid. Actions taken by a computer program when invalid data is encountered varies.

To facilitate identification of invalid data at runtime, a compiler option has been provided that specifies that the validity of certain data formats is to be checked. The data is checked at runtime by selecting portions of bitstrings to be checked and comparing those portions against valid bitstrings. A message is displayed indicating the location of the invalid data so that it may be corrected.

Improvements to testing the validity of data are sought to improve processing within the computing environment.

### SUMMARY

Shortcomings of the prior art are overcome, and additional advantages are provided through the provision of a computer program product for facilitating processing within a computing environment. The computer program product includes a set of one or more computer readable storage media and program instructions, collectively stored in the set of one or more computer readable storage media, for causing at least one computing device to perform the following computer operations. The computer operations include executing an instruction to perform validity testing of a source value. The executing the instruction includes obtaining the source value using at least one field of the instruction and performing validity testing of at least a portion of the source value. The performing the validity testing is based on one or more test controls obtained using a field of the instruction. The performing the validity testing determines whether a format of the at least the portion of the source value adheres to a data format variation specified by, at least, the one or more test controls. The performing the validity testing provides a result, and the result is provided for use in further processing.

By executing an instruction that performs validity testing based on one or more test controls of the instruction, improved processing within the computing environment is provided. Various tests of a format of a source value may be specified and/or performed using the instruction. A single instruction (e.g., a single architected instruction) is used to test whether a format of at least a portion of a source value adheres to a data format variation, in which the data format variation is one of a plurality of data format variations specified by test controls of the instruction. One instruction is used to test for a plurality of different data format variations. The instruction is a fast instruction (compared to performing various tests and branches based thereon within a computer application) that comprehensively checks the validity of a format of a source value, as defined by the test controls. The speed of validity testing, during runtime, is increased enabling validity checking to be performed in different environments including production environments. Use in production environments avoids or minimizes significant and expensive downtime. The accuracy within computer applications is increased, and therefore, processing within a processor, by providing an efficient, flexible validity testing capability. The capability efficiently provides program correctness/robustness by explicitly and quickly flagging incorrect data such that it is noticed and remedied.

In one or more aspects, a computer program product for facilitating processing within a computing environment is provided. The computer program product includes a set of one or more computer readable storage media, and program instructions, collectively stored in the set of one or more computer readable storage media, for causing at least one computing device to perform computer operations. The computer operations include executing an instruction to perform validity testing of a source value. The executing the instruction includes performing validity testing of at least a portion of the source value based on a plurality of test controls obtained using a field of the instruction. The performing the validity testing includes determining that a format of the at least the portion of the source value adheres to a data format variation specified by, at least, one or more test controls of the plurality of test controls, and ascertaining, using at least one test control of the plurality of test controls, that one or more digits and a sign code of the at least the portion of the source value are valid. A result of the validity testing is provided for use in further processing.

By executing an instruction that performs validity testing based on one or more test controls of a plurality of test controls of the instruction, improved processing within the computing environment is provided. Various tests of a format of at least a portion of a source value may be specified and/or performed using the instruction. A single instruction (e.g., a single architected instruction) is used to test that a format of at least a portion of a source value adheres to a data format variation, in which the data format variation is one of a plurality of data format variations specified by test controls of the instruction. One instruction is used to test for a plurality of different data format variations. Further, validity of digits and a sign code of the source value are tested using the single instruction. The instruction is a fast instruction (compared to performing various tests and branches based thereon within a computer application) that comprehensively checks the validity of a format, digits and sign code of a source value, as defined by the test controls. The speed of validity testing, during runtime, is increased enabling validity checking to be performed in different environments including production environments. The accuracy within computer applications is increased, and therefore, processing within a processor, by providing an efficient, flexible validity testing capability.

In one or more aspects, a computer program product for facilitating processing within a computing environment is provided. The computer program product includes a set of one or more computer readable storage media, and program instructions, collectively stored in the set of one or more computer readable storage media, for causing at least one computing device to perform computer operations. The computer operations include executing an instruction to perform validity testing of a decimal number in a zoned format. The executing the instruction includes performing validity testing of the decimal number based on a plurality of test controls obtained using a field of the instruction. The performing the validity testing includes determining that a format of the decimal number adheres to a zoned format variation specified by, at least, one or more test controls of the plurality of test controls, and ascertaining, using at least one test control of the plurality of test controls, that one or more digits and a sign code of the decimal number are valid. A result of the validity testing is provided in a condition code of the instruction for use in further processing.

By executing an instruction that performs validity testing based on one or more test controls of a plurality of test controls of the instruction, improved processing within the computing environment is provided. Various tests of a format of a decimal number may be specified and/or performed using the instruction. A single instruction (e.g., a single architected instruction) is used to test that a format of the decimal number adheres to a zoned format variation, in which the zoned format variation is one of a plurality of zoned format variations specified by test controls of the instruction. One instruction is used to test for a plurality of different zoned format variations. Further, validity of digits and a sign code of the decimal number are tested using the single instruction. The instruction is a fast instruction (compared to performing various tests and branches based thereon within a computer application) that comprehensively checks the validity of a format, digits and sign code of a decimal number, as defined by the test controls. The speed of validity testing, during runtime, is increased enabling validity checking to be performed in different environments including production environments. The accuracy within computer applications is increased, and therefore, processing within a processor, by providing an efficient, flexible validity testing capability.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2 depicts one example of further details of a processor of the processor set of FIG. 1, in accordance with one or more aspects of the present disclosure;

FIG. 3A depicts one example of sub-modules of a validity testing module of FIG. 1, in accordance with one or more aspects of the present disclosure;

FIG. 3B depicts one example of sub-modules of the execute instruction sub-module of FIG. 3A, in accordance with one or more aspects of the present disclosure;

FIG. 4 depicts one example of validity testing processing, in accordance with one or more aspects of the present disclosure;

FIG. 5A depicts one example of a format of a Vector Test Zoned instruction, in accordance with one or more aspects of the present disclosure;

FIG. 5B depicts one example of test controls of a control field of the Vector Test Zoned instruction, in accordance with one or more aspects of the present disclosure;

FIG. 6 depicts one example of vector test zoned instruction processing, in accordance with one or more aspects of the present disclosure; and

FIGS. 7A-7B depict another example of a computing environment to incorporate and use one or more aspects of the present disclosure.

### DETAILED DESCRIPTION

In accordance with one or more aspects of the present disclosure, a capability is provided to facilitate processing within a computing environment. In one aspect, the capability includes testing the validity of data used by one or more computer applications (also referred to as applications, computer programs, programs, etc.). The capability includes an instruction to test the data based on test controls specified by the instruction. In one example, a source value of the instruction (i.e., a source value obtained using one or more fields of the instruction) is the data to be tested. For instance, the data is validity tested to determine whether a format of the data adheres to a selected data format (e.g., a selected data format variation). The instruction specifies one or more test controls used to test whether the format of the source value specified using the instruction adheres to a data format variation selected from a plurality of data format variations specified using the instruction.

In one example, the instruction is included in a computer application in one or more locations and may replace a plurality of individual checks performed within the computer application to test the validity of the data, along with one or more branches performed as part of the testing. In one or more aspects, the instruction is a single architected hardware machine instruction at the hardware/software interface. As an example, it is part of an instruction set architecture. The single instruction replaces the plurality of checks that are performed independently, and which may use multiple clock cycles. As an example, execution of the single instruction performs, in one or more instances, a plurality of validity tests in fewer clock cycles than the multiple clock cycles used by the plurality of checks. In one example, execution of the single instruction performs the plurality of validity tests in a single clock cycle (or another number of clock cycles fewer than the multiple clock cycles). Execution of the single instruction replaces the individual data validity checks (and/or additional, fewer and/or other checks) of the computer application and one or more associated branches.

In one example, a single instruction (e.g., a single architected instruction) is defined and configured to perform various test scenarios to validate a data format (e.g., a format of data included in a source operand of the instruction). The various test scenarios are defined using a plurality of test controls included in one or more fields of the instruction. A test scenario of the various test scenarios is selected using one or more test controls of the plurality of test controls.

In one or more aspects, a computer program product for facilitating processing within a computing environment is provided. The computer program product includes a set of one or more computer readable storage media, and program instructions, collectively stored in the set of one or more computer readable storage media, for causing at least one computing device to perform the following computer operations including executing an instruction to perform validity testing of a source value. The executing the instruction includes obtaining the source value using at least one field of the instruction and performing validity testing of at least a portion of the source value. The performing the validity testing is based on one or more test controls obtained using a field of the instruction. The performing the validity testing determines whether a format of the at least the portion of the source value adheres to a data format variation specified by, at least, the one or more test controls. The performing the validity testing provides a result, and the result is provided for use in further processing. By executing an instruction that performs validity testing based on one or more test controls of the instruction, improved processing within the computing environment is provided. Various tests of a format of a source value may be specified and/or performed using the instruction. A single instruction (e.g., a single architected instruction) is used to test whether a format of at least a portion of a source value adheres to a data format variation, in which the data format variation is one of a plurality of data format variations specified by test controls of the instruction. One instruction is used to test for a plurality of different data format variations. The instruction is a fast instruction (compared to performing various tests and branches based thereon within a computer application) that comprehensively checks the validity of a format of a source value, as defined by the test controls. The speed of validity testing, during runtime, is increased enabling validity checking to be performed in different environments including production environments. Use in production environments avoids or minimizes significant and expensive downtime. The accuracy within computer applications is increased, and therefore, processing within a processor, by providing an efficient, flexible validity testing capability. The capability efficiently provides program correctness/robustness by explicitly and quickly flagging incorrect data such that it is noticed and remedied.

Additionally, or alternatively, in one or more embodiments, the providing the result includes including the result in a condition code returned at completion of executing the instruction. By placing the result in the condition code and returning the condition code, other portions of the computer application may check the condition code and use the result in further processing. This improves processing within the computer application.

Additionally, or alternatively, in one or more embodiments, the source value is a decimal value in a zoned format and the data format variation is a zoned format variation. An instruction (e.g., a single architected instruction) is configured to check for various zoned format variations, based on selected test controls. This replaces a number of individual tests and/or instructions to test for the various zoned formats, reducing processing cycles and improving performance.

Additionally, or alternatively, in one or more embodiments, the source value includes a plurality of data units, and the one or more test controls include a separate sign control specifying whether the source value is to include a sign in a data unit of the plurality of data units separate from other data units of the plurality of data units that include digits and a leading sign specifying a particular data unit of the plurality of data units of the source value to include a sign of the source value. The performing the validity testing includes using the separate sign control and the leading sign to determine the data format variation for which the format of the at least the portion of the source value is to adhere and checking that the format of the at least the portion of the source value complies to the data format variation. This provides flexibility and efficiency in testing compliance with data format variations.

Additionally, or alternatively, in one or more embodiments, based on selected settings of the separate sign control and the leading sign, the data format variation is an embedded leading sign type zoned format. One instruction (e.g., a single architected instruction) is configured to test for this data format, as well as others. This increases processing speed, reduces the number of instructions needed and improves performance.

Additionally, or alternatively, in one or more embodiments, based on particular settings of the separate sign control and the leading sign, the data format variation is a separate trailing sign type zoned format. One instruction (e.g., a single architected instruction) is configured to test for this data format, as well as others. This increases processing speed, reduces the number of instructions needed and improves performance.

Additionally, or alternatively, in one or more embodiments, based on chosen settings of the separate sign control and the leading sign, the data format variation is a separate leading sign type zoned format. One instruction (e.g., a single architected instruction) is configured to test for this data format, as well as others. This increases processing speed, reduces the number of instructions needed and improves performance.

Additionally, or alternatively, in one or more embodiments, the one or more test controls further include a disallowed spaces count specifying a number of selected data units of the plurality of data units of the source value not to contain characters representing spaces. Further, the performing the validity testing includes using the separate sign control, the leading sign and the disallowed spaces count to determine the data format variation for which the format of the at least the portion of the source value is to adhere. The use of various test controls enables one instruction to test the validity of different data formats of a source value, providing flexibility, efficiencies and increased performance. The disallowed spaces count enables one instruction to flexibly identify how many data units (e.g., bytes) are not to contain spaces. It provides flexibility on what is defined as a valid input string. A certain number of leading spaces is allowed to accommodate certain computer programming languages. In one example, the test is for disallowed spaces count, rather than allowed spaces count, for ease in hardware implementation. However, in other embodiments, allowed spaces count may be used.

Additionally, or alternatively, in one or more embodiments, the one or more test controls further include a digits count specifying a number of data units of the plurality of data units of the source value to contain a digit. Moreover, the performing the validity testing includes using the separate sign control, the leading sign, the disallowed spaces count and the digits count to determine the data format variation for which the format of the at least the portion of the source value is to adhere. The use of various test controls enables one instruction to test the validity of different data formats of a source value, providing flexibility, efficiencies and increased performance. The digits count enables one instruction to flexibly specify how many data units (e.g., bytes) are to contain digits.

Additionally, or alternatively, in one or more embodiments, based on defined settings of the separate sign control and the leading sign and based on the disallowed spaces count having a predetermined relationship with the digits count, the data format variation is an embedded trailing sign type zoned format. One instruction (e.g., a single architected instruction) is configured to test for this data format, as well as others. This increases processing speed, reduces the number of instructions needed and improves performance.

Additionally, or alternatively, in one or more embodiments, based on defined settings of the separate sign control and the leading sign and based on the disallowed spaces count having a predefined relationship with the digits count, the data format variation is a spaced embedded trailing sign type zoned format. One instruction (e.g., a single architected instruction) is configured to test for this data format, as well as others. This increases processing speed, reduces the number of instructions needed and improves performance.

Additionally, or alternatively, in one or more embodiments, the source value includes a plurality of data units, and the data format variation specifies one or more data unit formats for at least a set of data units of the plurality of data units. The one or more data unit formats are of a plurality of data unit formats. One instruction (e.g., a single architected instruction) can further define and be configured for validity testing of a source value that may have one format of a plurality of formats and each format may have different data unit formats. This provides flexibility, enhances validity testing and improves execution of computer applications using source values of different formats.

Additionally, or alternatively, in one or more embodiments, the plurality of data units is a plurality of bytes. The plurality of data unit formats includes a sign and digit byte format, a zone and digit byte format, a space byte format, and a separate sign byte format. One instruction (e.g., a single architected instruction) can further define and be configured for validity testing of a source value that may have one format of a plurality of formats and each format may have different data unit formats. This provides flexibility, enhances validity testing and improves execution of computer applications using source values of different formats.

In accordance with one or more aspects, each of the embodiments is separable and optional from one another. Further, embodiments may be combined with one another.

In one or more aspects, a computer program product for facilitating processing within a computing environment is provided. The computer program product includes a set of one or more computer readable storage media, and program instructions, collectively stored in the set of one or more computer readable storage media, for causing at least one computing device to perform the following computer operations including executing an instruction to perform validity testing of a source value. The source value is a decimal value in a zoned format. The executing the instruction includes obtaining the source value using at least one field of the instruction and performing validity testing of at least a portion of the source value. The performing the validity testing is based on one or more test controls obtained using a field of the instruction. The performing the validity testing determines whether a format of the at least the portion of the source value adheres to a data format variation specified by, at least, the one or more test controls. The data format variation is a zoned format variation. The performing the validity testing provides a result, and the result is provided for use in further processing. The providing the result includes including the result in a condition code returned at completion of executing the instruction. By executing an instruction that performs validity testing based on one or more test controls of the instruction, improved processing within the computing environment is provided. Various tests of a format of a source value may be specified and/or performed using the instruction. A single instruction (e.g., a single architected instruction) is used to test whether a format of at least a portion of a source value adheres to a data format variation, in which the data format variation is one of a plurality of data format variations specified by test controls of the instruction. One instruction is used to test for a plurality of different data format variations. The instruction is a fast instruction (compared to performing various tests and branches based thereon within a computer application) that comprehensively checks the validity of a format of a source value, as defined by the test controls. The speed of validity testing, during runtime, is increased enabling validity checking to be performed in different environments including production environments. Use in production environments avoids or minimizes significant and expensive downtime. The accuracy within computer applications is increased, and therefore, processing within a processor, by providing an efficient, flexible validity testing capability. The capability efficiently provides program correctness/robustness by explicitly and quickly flagging incorrect data such that it is noticed and remedied. By placing the result in the condition code and returning the condition code, other portions of the computer application may check the condition code and use the result in further processing. This improves processing within the computer application. An instruction (e.g., a single architected instruction) is configured to check for various zoned format variations, based on selected test controls. This replaces a number of individual tests and/or instructions to test for the various zoned formats, reducing processing cycles and improving performance.

In accordance with one or more aspects, each of the embodiments is separable and optional from one another. Further, embodiments may be combined with one another.

In one or more aspects, a computer program product for facilitating processing within a computing environment is provided. The computer program product includes a set of one or more computer readable storage media, and program instructions, collectively stored in the set of one or more computer readable storage media, for causing at least one computing device to perform the following computer operations including executing an instruction to perform validity testing of a source value. The source value includes a plurality of data units. The executing the instruction includes obtaining the source value using at least one field of the instruction and performing validity testing of at least a portion of the source value. The performing the validity testing is based on one or more test controls obtained using a field of the instruction. The one or more test controls include a separate sign control specifying whether the source value is to include a sign in a data unit of the plurality of data units separate from other data units of the plurality of data units that include digits and a leading sign specifying a particular data unit of the plurality of data units of the source value to include a sign of the source value. The performing the validity testing determines whether a format of the at least the portion of the source value adheres to a data format variation specified by, at least, the one or more test controls. The performing the validity testing includes using the separate sign control and the leading sign to determine the data format variation for which the format of the at least the portion of the source value is to adhere and checking that the format of the at least the portion of the source value complies to the data format variation. The performing validity testing provides a result, and the result is provided for use in further processing. The providing the result includes including the result in a condition code returned at completion of executing the instruction. By executing an instruction that performs the validity testing based on one or more test controls of the instruction, improved processing within the computing environment is provided. Various tests of a format of a source value may be specified and/or performed using the instruction. A single instruction (e.g., a single architected instruction) is used to test whether a format of at least a portion of a source value adheres to a data format variation, in which the data format variation is one of a plurality of data format variations specified by test controls of the instruction. One instruction is used to test for a plurality of different data format variations. The instruction is a fast instruction (compared to performing various tests and branches based thereon within a computer application) that comprehensively checks the validity of a format of a source value, as defined by the test controls. The speed of validity testing, during runtime, is increased enabling validity checking to be performed in different environments including production environments. Use in production environments avoids or minimizes significant and expensive downtime. The accuracy within computer applications is increased, and therefore, processing within a processor, by providing an efficient, flexible validity testing capability. The capability efficiently provides program correctness/robustness by explicitly and quickly flagging incorrect data such that it is noticed and remedied. By placing the result in the condition code and returning the condition code, other portions of the computer application may check the condition code and use the result in further processing. This improves processing within the computer application. Flexibility and efficiency in testing compliance with data format variations is provided.

In accordance with one or more aspects, each of the embodiments is separable and optional from one another. Further, embodiments may be combined with one another.

In one or more aspects, a computer program product for facilitating processing within a computing environment is provided. The computer program product includes a set of one or more computer readable storage media, and program instructions, collectively stored in the set of one or more computer readable storage media, for causing at least one computing device to perform the following computer operations including executing an instruction to perform validity testing of a source value. The source value includes a plurality of data units. The executing the instruction includes obtaining the source value using at least one field of the instruction and performing validity testing of at least a portion of the source value. The performing the validity testing is based on one or more test controls obtained using a field of the instruction. The performing the validity testing determines whether a format of the at least the portion of the source value adheres to a data format variation specified by, at least, the one or more test controls. The data format variation specifies one or more data unit formats for at least a set of data units of the plurality of data units. The one or more data unit formats are of a plurality of data unit formats. The performing the validity testing provides a result, and the result is provided for use in further processing. The providing the result includes including the result in a condition code returned at completion of executing the instruction. By executing an instruction that performs validity testing based on one or more test controls of the instruction, improved processing within the computing environment is provided. Various tests of a format of a source value may be specified and/or performed using the instruction. A single instruction (e.g., a single architected instruction) is used to test whether a format of at least a portion of a source value adheres to a data format variation, in which the data format variation is one of a plurality of data format variations specified by test controls of the instruction. One instruction is used to test for a plurality of different data format variations. The instruction is a fast instruction (compared to performing various tests and branches based thereon within a computer application) that comprehensively checks the validity of a format of a source value, as defined by the test controls. The speed of validity testing, during runtime, is increased enabling validity checking to be performed in different environments including production environments. Use in production environments avoids or minimizes significant and expensive downtime. The accuracy within computer applications is increased, and therefore, processing within a processor, by providing an efficient, flexible validity testing capability. The capability efficiently provides program correctness/robustness by explicitly and quickly flagging incorrect data such that it is noticed and remedied. By placing the result in the condition code and returning the condition code, other portions of the computer application may check the condition code and use the result in further processing. This improves processing within the computer application. One instruction (e.g., a single architected instruction) can further define and be configured for validity testing of a source value that may have one format of a plurality of formats and each format may have different data unit formats. This provides flexibility, enhances validity testing and improves execution of computer applications using source values of different formats.

In accordance with one or more aspects, each of the embodiments is separable and optional from one another. Further, embodiments may be combined with one another.

In one or more aspects, a computer program product for facilitating processing within a computing environment is provided. The computer program product includes a set of one or more computer readable storage media, and program instructions, collectively stored in the set of one or more computer readable storage media, for causing at least one computing device to perform the following computer operations including executing an instruction to perform validity testing of a source value. The source value includes a plurality of data units. The executing the instruction includes obtaining the source value using at least one field of the instruction and performing validity testing of at least a portion of the source value. The performing the validity testing is based on one or more test controls obtained using a field of the instruction. The one or more test controls include a separate sign control specifying whether the source value is to include a sign in a data unit of the plurality of data units separate from other data units of the plurality of data units that include digits and a leading sign specifying a particular data unit of the plurality of data units of the source value to include a sign of the source value. The performing the validity testing determines whether a format of the at least the portion of the source value adheres to a data format variation specified by, at least, the one or more test controls. The performing the validity testing includes using the separate sign control and the leading sign to determine the data format variation for which the format of the at least the portion of the source value is to adhere and checking that the format of the at least the portion of the source value complies to the data format variation. The data format variation specifies one or more data unit formats for at least a set of data units of the plurality of data units. The one or more data unit formats are of a plurality of data unit formats. The performing the validity testing provides a result, and the result is provided for use in further processing. By executing an instruction that performs validity testing based on one or more test controls of the instruction, improved processing within the computing environment is provided. Various tests of a format of a source value may be specified and/or performed using the instruction. A single instruction (e.g., a single architected instruction) is used to test whether a format of at least a portion of the source value adheres to a data format variation, in which the data format variation is one of a plurality of data format variations specified by test controls of the instruction. One instruction is used to test for a plurality of different data format variations. The instruction is a fast instruction (compared to performing various tests and branches based thereon within a computer application) that comprehensively checks the validity of a format of a source value, as defined by the test controls. The speed of validity testing, during runtime, is increased enabling validity checking to be performed in different environments including production environments. Use in production environments avoids or minimizes significant and expensive downtime. The accuracy within computer applications is increased, and therefore, processing within a processor, by providing an efficient, flexible validity testing capability. The capability efficiently provides program correctness/robustness by explicitly and quickly flagging incorrect data such that it is noticed and remedied. Processing within a computer application is improved. One instruction (e.g., a single architected instruction) can further define and be configured for validity testing of a source value that may have one format of a plurality of formats and each format may have different data unit formats. This provides flexibility, enhances validity testing and improves execution of computer applications using source values of different formats. Flexibility and efficiency in testing compliance with data format variations is provided.

In accordance with one or more aspects, each of the embodiments is separable and optional from one another. Further, embodiments may be combined with one another.

In one or more aspects, a computer system for facilitating processing within a computing environment is provided. The computer system includes at least one computing device, a set of one or more computer readable storage media, and program instructions, collectively stored in the set of one or more computer readable storage media, for causing the at least one computing device to perform the following computer operations including executing an instruction to perform validity testing of a source value. The executing the instruction includes obtaining the source value using at least one field of the instruction and performing validity testing of at least a portion of the source value. The performing the validity testing is based on one or more test controls obtained using a field of the instruction. The performing the validity testing determines whether a format of the at least the portion of the source value adheres to a data format variation specified by, at least, the one or more test controls. The performing the validity testing provides a result, and the result is provided for use in further processing. By executing an instruction that performs validity testing based on one or more test controls of the instruction, improved processing within the computing environment is provided. Various tests of a format of a source value may be specified and/or performed using the instruction. A single instruction (e.g., a single architected instruction) is used to test whether a format of at least a portion of a source value adheres to a data format variation, in which the data format variation is one of a plurality of data format variations specified by test controls of the instruction. One instruction is used to test for a plurality of different data format variations. The instruction is a fast instruction (compared to performing various tests and branches based thereon within a computer application) that comprehensively checks the validity of a format of a source value, as defined by the test controls. The speed of validity testing, during runtime, is increased enabling validity checking to be performed in different environments including production environments. Use in production environments avoids or minimizes significant and expensive downtime. The accuracy within computer applications is increased, and therefore, processing within a processor, by providing an efficient, flexible validity testing capability. The capability efficiently provides program correctness/robustness by explicitly and quickly flagging incorrect data such that it is noticed and remedied.

Additionally, or alternatively, in one or more embodiments, the providing the result includes including the result in a condition code returned at completion of executing the instruction. By placing the result in the condition code and returning the condition code, other portions of the computer application may check the condition code and use the result in further processing. This improves processing within the computer application.

Additionally, or alternatively, in one or more embodiments, the source value is a decimal value in a zoned format and the data format variation is a zoned format variation. An instruction (e.g., a single architected instruction) is configured to check for various zoned format variations, based on selected test controls. This replaces a number of individual tests and/or instructions to test for the various zoned formats, reducing processing cycles and improving performance.

Additionally, or alternatively, in one or more embodiments, the source value includes a plurality of data units, and the one or more test controls include a separate sign control specifying whether the source value is to include a sign in a data unit of the plurality of data units separate from other data units of the plurality of data units that include digits and a leading sign specifying a particular data unit of the plurality of data units of the source value to include a sign of the source value. The performing the validity testing includes using the separate sign control and the leading sign to determine the data format variation for which the format of the at least the portion of the source value is to adhere and checking that the format of the at least the portion of the source value complies to the data format variation. This provides flexibility and efficiency in testing compliance with data format variations.

Additionally, or alternatively, in one or more embodiments, the one or more test controls further include a disallowed spaces count specifying a number of selected data units of the plurality of data units of the source value not to contain characters representing spaces. Further, the performing the validity testing includes using the separate sign control, the leading sign and the disallowed spaces count to determine the data format variation for which the format of the at least the portion of the source value is to adhere. The use of various test controls enables one instruction to test the validity of different data formats of a source value, providing flexibility, efficiencies and increased performance. The disallowed spaces count enables one instruction to flexibly identify how many data units (e.g., bytes) are not to contain spaces. It provides flexibility on what is defined as a valid input string. A certain number of leading spaces is allowed to accommodate certain computer programming languages. In one example, the test is for disallowed spaces count, rather than allowed spaces count, for ease in hardware implementation. However, in other embodiments, allowed spaces count may be used.

Additionally, or alternatively, in one or more embodiments, the one or more test controls further include a digits count specifying a number of data units of the plurality of data units of the source value to contain a digit. Moreover, the performing the validity testing includes using the separate sign control, the leading sign, the disallowed spaces count and the digits count to determine the data format variation for which the format of the at least the portion of the source value is to adhere. The use of various test controls enables one instruction to test the validity of different data formats of a source value, providing flexibility, efficiencies and increased performance. The digits count enables one instruction to flexibly specify how many data units (e.g., bytes) are to contain digits.

In accordance with one or more aspects, each of the embodiments is separable and optional from one another. Further, embodiments may be combined with one another.

In one or more aspects, a computer-implemented method of facilitating processing within a computing environment is provided. The computer-implemented method includes executing an instruction to perform validity testing of a source value. The executing the instruction includes obtaining the source value using at least one field of the instruction and performing validity testing of at least a portion of the source value. The performing the validity testing is based on one or more test controls obtained using a field of the instruction. The performing the validity testing determines whether a format of the at least the portion of the source value adheres to a data format variation specified by, at least, the one or more test controls. The performing the validity testing provides a result, and the result is provided for use in further processing. By executing an instruction that performs validity testing based on one or more test controls of the instruction, improved processing within the computing environment is provided. Various tests of a format of a source value may be specified and/or performed using the instruction. A single instruction (e.g., a single architected instruction) is used to test whether a format of at least a portion of a source value adheres to a data format variation, in which the data format variation is one of a plurality of data format variations specified by test controls of the instruction. One instruction is used to test for a plurality of different data format variations. The instruction is a fast instruction (compared to performing various tests and branches based thereon within a computer application) that comprehensively checks the validity of a format of a source value, as defined by the test controls. The speed of validity testing, during runtime, is increased enabling validity checking to be performed in different environments including production environments. Use in production environments avoids or minimizes significant and expensive downtime. The accuracy within computer applications is increased, and therefore, processing within a processor, by providing an efficient, flexible validity testing capability. The capability efficiently provides program correctness/robustness by explicitly and quickly flagging incorrect data such that it is noticed and remedied.

Additionally, or alternatively, in one or more embodiments, the providing the result includes including the result in a condition code returned at completion of executing the instruction. By placing the result in the condition code and returning the condition code, other portions of the computer application may check the condition code and use the result in further processing. This improves processing within the computer application.

Additionally, or alternatively, in one or more embodiments, the source value is a decimal value in a zoned format and the data format variation is a zoned format variation. An instruction (e.g., a single architected instruction) is configured to check for various zoned format variations, based on selected test controls. This replaces a number of individual tests and/or instructions to test for the various zoned formats, reducing processing cycles and improving performance.

Additionally, or alternatively, in one or more embodiments, the source value includes a plurality of data units, and the one or more test controls include a separate sign control specifying whether the source value is to include a sign in a data unit of the plurality of data units separate from other data units of the plurality of data units that include digits and a leading sign specifying a particular data unit of the plurality of data units of the source value to include a sign of the source value. The performing the validity testing includes using the separate sign control and the leading sign to determine the data format variation for which the format of the at least the portion of the source value is to adhere and checking that the format of the at least the portion of the source value complies to the data format variation. This provides flexibility and efficiency in testing compliance with data format variations.

Additionally, or alternatively, in one or more embodiments, the one or more test controls further include a disallowed spaces count specifying a number of selected data units of the plurality of data units of the source value not to contain characters representing spaces. Further, the performing the validity testing includes using the separate sign control, the leading sign and the disallowed spaces count to determine the data format variation for which the format of the at least the portion of the source value is to adhere. The use of various test controls enables one instruction to test the validity of different data formats of a source value, providing flexibility, efficiencies and increased performance. The disallowed spaces count enables one instruction to flexibly identify how many data units (e.g., bytes) are not to contain spaces. It provides flexibility on what is defined as a valid input string. A certain number of leading spaces is allowed to accommodate certain computer programming languages. In one example, the test is for disallowed spaces count, rather than allowed spaces count, for ease in hardware implementation. However, in other embodiments, allowed spaces count may be used.

Additionally, or alternatively, in one or more embodiments, the one or more test controls further include a digits count specifying a number of data units of the plurality of data units of the source value to contain a digit. Moreover, the performing the validity testing includes using the separate sign control, the leading sign, the disallowed spaces count and the digits count to determine the data format variation for which the format of the at least the portion of the source value is to adhere. The use of various test controls enables one instruction to test the validity of different data formats of a source value, providing flexibility, efficiencies and increased performance. The digits count enables one instruction to flexibly specify how many data units (e.g., bytes) are to contain digits.

In accordance with one or more aspects, each of the embodiments is separable and optional from one another. Further, embodiments may be combined with one another.

In one or more aspects, a computer program product for facilitating processing within a computing environment is provided. The computer program product includes a set of one or more computer readable storage media, and program instructions, collectively stored in the set of one or more computer readable storage media, for causing at least one computing device to perform computer operations. The computer operations include executing an instruction to perform validity testing of a source value. The executing the instruction includes performing validity testing of at least a portion of the source value based on a plurality of test controls obtained using a field of the instruction. The performing the validity testing includes determining that a format of the at least the portion of the source value adheres to a data format variation specified by, at least, one or more test controls of the plurality of test controls, and ascertaining, using at least one test control of the plurality of test controls, that one or more digits and a sign code of the at least the portion of the source value are valid. A result of the validity testing is provided for use in further processing. By executing an instruction that performs validity testing based on one or more test controls of a plurality of test controls of the instruction, improved processing within the computing environment is provided. Various tests of a format of at least a portion of a source value may be specified and/or performed using the instruction. A single instruction (e.g., a single architected instruction) is used to test that a format of at least a portion of a source value adheres to a data format variation, in which the data format variation is one of a plurality of data format variations specified by test controls of the instruction. One instruction is used to test for a plurality of different data format variations. Further, validity of digits and a sign code of the source value are tested using the single instruction. The instruction is a fast instruction (compared to performing various tests and branches based thereon within a computer application) that comprehensively checks the validity of a format, digits and sign code of a source value, as defined by the test controls. The speed of validity testing, during runtime, is increased enabling validity checking to be performed in different environments including production environments. The accuracy within computer applications is increased, and therefore, processing within a processor, by providing an efficient, flexible validity testing capability.

In accordance with one or more aspects, each of the embodiments is separable and optional from one another. Further, embodiments may be combined with one another.

In one or more aspects, a computer program product for facilitating processing within a computing environment is provided. The computer program product includes a set of one or more computer readable storage media, and program instructions, collectively stored in the set of one or more computer readable storage media, for causing at least one computing device to perform computer operations. The computer operations include executing an instruction to perform validity testing of a decimal number in a zoned format. The executing the instruction includes performing validity testing of the decimal number based on a plurality of test controls obtained using a field of the instruction. The performing the validity testing includes determining that a format of the decimal number adheres to a zoned format variation specified by, at least, one or more test controls of the plurality of test controls, and ascertaining, using at least one test control of the plurality of test controls, that one or more digits and a sign code of the decimal number are valid. A result of the validity testing is provided in a condition code of the instruction for use in further processing. By executing an instruction that performs validity testing based on one or more test controls of a plurality of test controls of the instruction, improved processing within the computing environment is provided. Various tests of a format of a decimal number may be specified and/or performed using the instruction. A single instruction (e.g., a single architected instruction) is used to test that a format of the decimal number adheres to a zoned format variation, in which the zoned format variation is one of a plurality of zoned format variations specified by test controls of the instruction. One instruction is used to test for a plurality of different zoned format variations. Further, validity of digits and a sign code of the decimal number are tested using the single instruction. The instruction is a fast instruction (compared to performing various tests and branches based thereon within a computer application) that comprehensively checks the validity of a format, digits and sign code of a decimal number, as defined by the test controls. The speed of validity testing, during runtime, is increased enabling validity checking to be performed in different environments including production environments. The accuracy within computer applications is increased, and therefore, processing within a processor, by providing an efficient, flexible validity testing capability.

In accordance with one or more aspects, each of the embodiments is separable and optional from one another. Further, embodiments may be combined with one another.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that, e.g., performs validity testing and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

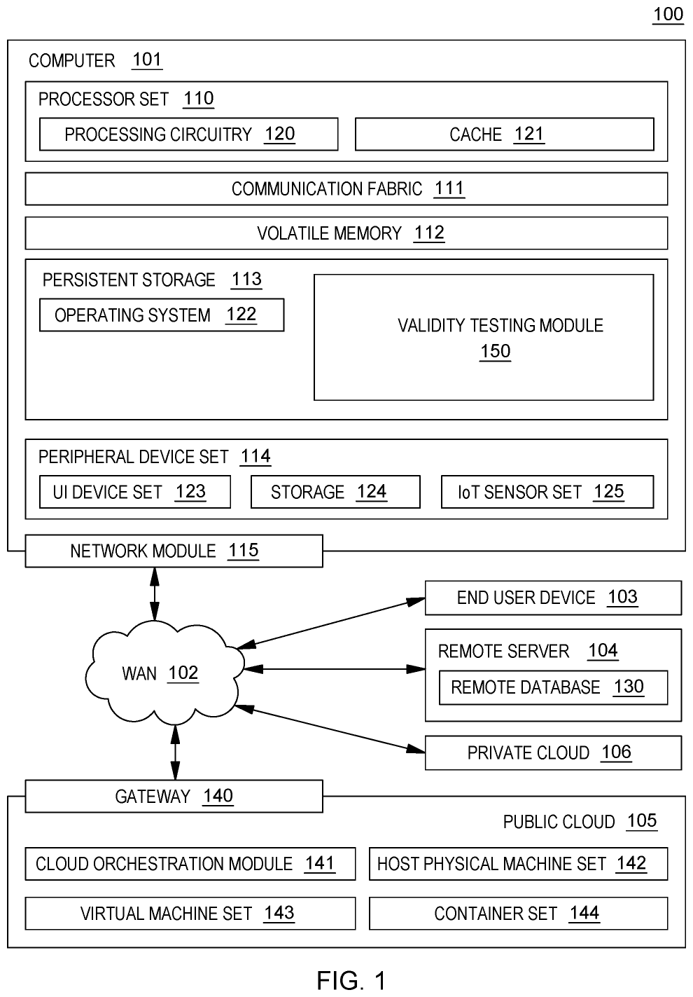

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as validity testing code or module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

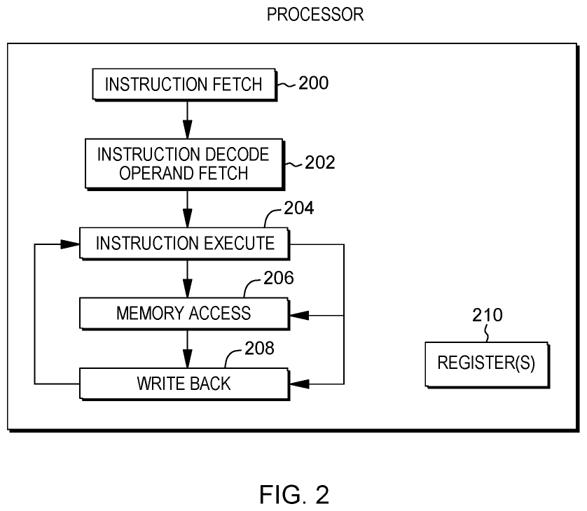

In one example, a processor (e.g., of processor set 110) includes a plurality of functional components (or a subset thereof) used to execute instructions. As depicted in FIG. 2, in one example, these functional components include, for instance, an instruction fetch component 200 to fetch instructions to be executed; an instruction decode/operand fetch component 202 to decode the fetched instructions and to obtain operands of the decoded instructions; one or more instruction execute components 204 to execute the decoded instructions; a memory access component 206 to access memory for instruction execution, if necessary; and a write back component 208 to provide the results of the executed instructions. One or more of the components may access and/or use one or more registers 210 in instruction processing. Further, one or more of the components may access and/or use validity testing module 150. Additionally, fewer and/or other components may be used in one or more aspects of the present disclosure.

In one example, a validity testing module (e.g., validity testing module 150) is used, in accordance with one or more aspects of the present disclosure. A validity testing module (e.g., validity testing module 150) includes code or instructions used to perform validity testing, in accordance with one or more aspects of the present disclosure. A validity testing module (e.g., validity testing module 150) includes, in one example, various sub-modules to be used to perform the processing. The sub-modules are, e.g., computer readable program code (e.g., instructions) in computer readable media, e.g., storage (persistent storage 113, cache 121, storage 124, other storage, as examples). The computer readable storage media may be part of one or more computer program products and the computer readable program code may be executed by and/or using one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute one or more of the sub-modules and/or portions thereof. Many examples are possible.

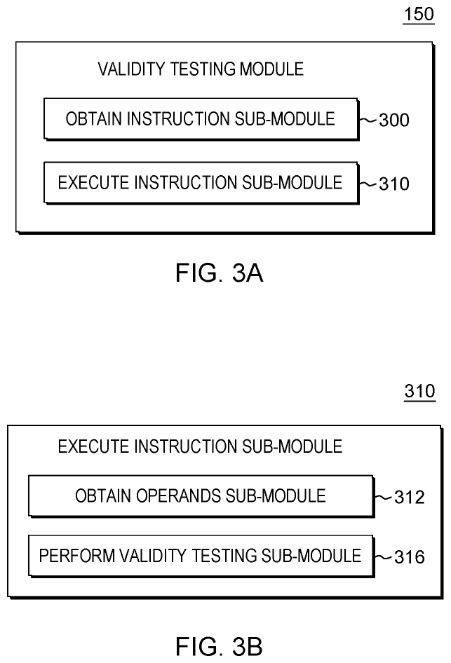

One example of validity testing module 150 is described with reference to FIG. 3A. In one example, validity testing module 150 includes an obtain instruction sub-module 300 to obtain (e.g., receive, be provided, pull, retrieve, fetch, etc.) a validity testing instruction to be executed, and an execute instruction sub-module 310 to be used to execute the validity testing instruction.

In one example, referring to FIG. 3B, execute instruction sub-module 310 includes, for instance, an obtain operands sub-module 312 to obtain one or more operands of the validity testing instruction; and a perform validity testing sub-module 316 to perform validity testing on data (e.g., a source value) obtained using the validity testing instruction based on one or more test controls specified using the validity testing instruction.

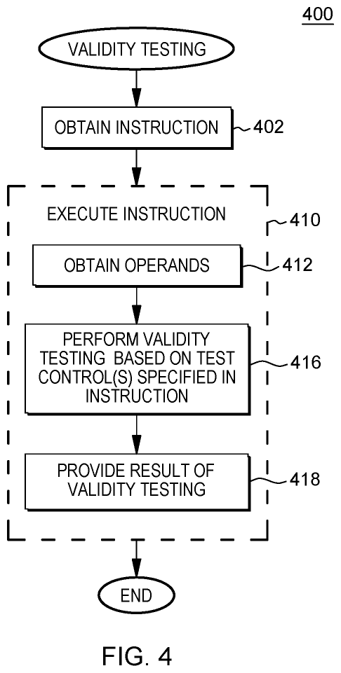

One or more of the sub-modules (e.g., sub-modules 300, 310-316) are used, in accordance with one or more aspects of the present disclosure, to perform a validity testing process on a source value (e.g., a decimal value (e.g., a decimal number) in a zoned format). In one example, referring to FIG. 4, a validity testing process 400 is executed by one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute the process and/or aspects thereof. Many examples are possible.

Referring to FIG. 4, in one example, validity testing process 400 (also referred to as process 400) obtains 402 (e.g., receives, retrieves, fetches, is provided, pulls, etc.) an instruction (e.g., a validity testing instruction) and executes 410 the instruction. Execution of the validity testing instruction includes, for instance, obtaining 412 one or more operands of the validity testing instruction. As examples, process 400 obtains one or more source operands that include the source value to be tested and a control operand that specifies one or more tests to be performed on the source value to be tested. Further, in one or more embodiments, additional, fewer and/or other operands may be used. The operands to be obtained depend, for instance, on which operands are specified using the instruction and/or are being used. For one or more instructions, one or more operands may be optional and may not be used in various embodiments. Many variations are possible.

Based on obtaining the operands, in one example, process 400 performs 416 validity testing (e.g., performs one or more tests) to determine the validity of the data (e.g., the source value). In one example, the one or more tests used are specified using the control operand. For example, process 400 performs validity testing of at least a portion of the source value based on one or more (e.g., a plurality of) test controls obtained using a field (e.g., the control operand) of the instruction. As an example, the validity testing determines whether the source value (e.g., at least a portion of the source value) adheres to a data format variation specified by the one or more test controls.

Based on performing the validity testing, a result from the validity testing is determined, and, in one example, process 400 provides 418 the result. For instance, the result is returned in a condition code of the instruction. The result may be used in other processing. For example, the result is returned to the computer application that issued the validity testing instruction and processing within the computer application is performed based on whether the source value (e.g., the decimal value in a zoned format) is valid (e.g., as determined by the validity testing, and in particular, the one or more tests performed based on the test controls). In one or more examples, the processing within the computer application may depend on whether the source value adheres to a variation of the zoned format, as specified by the test controls. Various examples are possible.

In accordance with one or more aspects, a validity testing instruction is a vector test instruction to be used to test the validity of a source value specified by the instruction and using one or more test controls indicated by the instruction. One example of a vector test instruction is a vector test zoned instruction, one example of which is further described below. Other examples are possible.

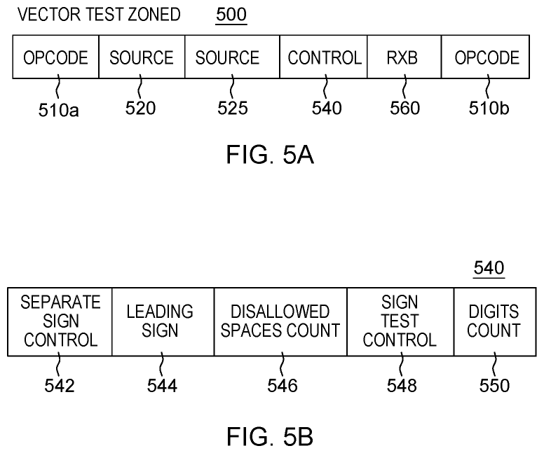

One example of a vector test zoned instruction is described with reference to FIGS. 5A-5B. In one example, a vector test zoned instruction, such as a Vector Test Zoned instruction 500, is a single architected hardware machine instruction at the hardware/software interface. As an example, it is part of an instruction set architecture. One example of an instruction set architecture to incorporate and/or use a vector test zoned instruction and/or aspects of the present disclosure is the z/Architecture© instruction set architecture offered by International Business Machines Corporation, Armonk, New York. One embodiment of the z/Architecture instruction set architecture is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present disclosure. z/Architecture and IBM are trademarks or registered trademarks of International Business Machines Corporation in at least one jurisdiction.

In one example, the Vector Test Zoned instruction is part of a vector facility of an instruction set architecture. The vector facility provides, for instance, fixed sized vectors ranging from, e.g., one to sixteen elements. Each vector includes data which is operated on by vector instructions defined in the facility. In one embodiment, if a vector is made up of multiple elements, then each element is processed in parallel with the other elements. Instruction completion does not occur, in one example, until processing of all the elements is complete. In other embodiments, the elements are processed partially in parallel and/or sequentially; and/or there may be additional elements.

In one embodiment, the vector instructions use vector registers that include the vectors. For instance, each vector register is, e.g., 128 bits in length and includes one to sixteen equal sized elements. If there are multiple elements in the register, the elements are indexed from left to right starting with element zero. In one example, the vector facility includes 32 vector registers, which are part of a register file. The register file is an array of processor registers in, e.g., a central processing unit (e.g., a processor of processor set 110; e.g., processor 200) that includes registers that may be used for instruction processing. In one example, the register file includes the vector registers (e.g., 32 vector registers) and other types of registers can map to a quadrant of the vector registers. For instance, sixteen floating point registers, which are 64 bits in length, can overlay the vector registers. Thus, as an example, when floating point register 2 is modified, then vector register 2 is also modified. Other mappings for other types of registers are also possible.

Vector data appears in storage in, for instance, a left-to-right sequence, similar to other data formats. Bits of a data format that are numbered 0-7 constitute the byte in the leftmost (lowest-numbered) byte location in storage, bits 8-15 form the byte in the next sequential location, and so on. In a further example, the vector data may appear in storage in another sequence, such as right-to-left.

Continuing with FIG. 5A, Vector Test Zoned instruction 500 includes a plurality of fields, including one or more operation code (opcode) fields 510a, 510b that indicate that this is a vector test zoned operation; a plurality of source fields 520, 525 used to designate a plurality of source locations (e.g., a plurality of vector registers) that includes a plurality of source operands of the instruction; a control field 540 to specify one or more test controls to be used to control processing of the instruction; and a register extension bit (RXB) field 560 to be used, in one example, with the source fields to designate the source location (e.g., vector register(s)) used by the instruction, as described below.

In one particular example, Vector Test Zoned instruction 500 has a format, referred to as a vector register and immediate operand with an extended opcode format, having, e.g., 48 bits. In this particular example, Vector Test Zoned instruction 500 has multiple operation code fields 510a, 510b (e.g., bits 0-7 and 40-47); source field 520 (also referred to as V₁ specifying at least one vector register) in, e.g., bits 12-15; source field 525 (also referred to as V₂ specifying at least one vector register) in, e.g., bits 16-19; control field 540 (also referred to as an immediate field or I₂) in, e.g., bits 20-35; and register extension bit (RXB) field 560 in, e.g., bits 36-39. Although in this example there are a plurality of opcode fields 510a, 510b, in other examples, there may be one opcode field. For instance, there may be one opcode field at the beginning of the instruction format. Other examples are also possible.

In one example, register extension bit (RXB) field 560 includes the most significant bit for a vector register designated operand. Bits for register designations not specified by the instruction are to be reserved and set to zero. The most significant bit is concatenated, for instance, to the left of a four-bit register designation of the vector register field (e.g., V₁, V₂) to create a five-bit vector register designation.

In one example, the RXB field includes four bits (e.g., bits 0-3), and the bits are defined, as follows:
0—Most significant bit for the vector register designation in, e.g., bits 8-11 of the instruction, if any.
1—Most significant bit for the vector register designation in, e.g., bits 12-15 of the instruction, if any.
2—Most significant bit for the vector register designation in, e.g., bits 16-19 of the instruction, if any.
3—Most significant bit for the vector register designation in, e.g., bits 32-35 of the instruction, if any.

Each bit is set to zero or one by, for instance, the assembler depending on the register number. For instance, for registers 0-15, the bit is set to 0; for registers 16-31, the bit is set to 1, etc. Thus, a register containing an operand is specified using, for instance, a four-bit field of the register field with the addition of its corresponding register extension bit (RXB) as the most significant bit. For instance, if the four-bit field is 0110 and the extension bit is 0, then the five bit field 00110 indicates register number 6. In a further embodiment, the RXB field includes additional bits, and more than one bit is used as an extension for each vector or location. Further, in other embodiments, the assignment of RXB bits to operands and/or bits of the instruction format may be different than the example herein. Other variations are possible.

In one example, referring to FIG. 5B, control field 540 includes a plurality of test controls, one or more of which are used to control validity testing of the source value. In one example, the source value is a decimal value (e.g., a decimal number) that includes one or more data units (e.g., bytes). In one example, control field 540 includes a separate sign control 542 that specifies whether the source value is to include a sign in a data unit (e.g., byte) separate from other data units (e.g., bytes) that include digits; a leading sign 544 specifying that a particular data unit within the source value includes a sign of the source value; a disallowed spaces count 544 that specifies a number of selected data units of the source value not to contain characters representing spaces; a sign test control 546 that specifies which codes are considered valid sign codes; and a digits count 548 that specifies the number of data units of the source value which contain a digit. Each of the controls is further described below:

In one example, control field 540 includes:

Reserved (e.g., bit 0): In one example, this bit is reserved and should contain, e.g., zero; otherwise, the program may not operate compatibly in the future. Other variations are possible.

Separate sign control (SSC) 542 (e.g., bit 1): In one example, when separate sign control 542 is set to one value, e.g., 1, the decimal number in the source includes a byte designating the sign which is separate from, and to the left or right of, the bytes containing digits. When separate sign control 542 is set to another value, e.g., 0, the leftmost or rightmost byte containing a digit also contains the sign. Other variations are possible.

Leading sign (LS) 544 (e.g., bit 2): In one example, when leading sign 544 is set to one value, e.g., one, the leftmost byte of the decimal number in the source includes the sign. When leading sign 544 is set to another value, e.g., zero, the rightmost byte of the decimal number includes the sign. Other variations are possible.

Disallowed spaces count (DSC) 546 (e.g., bits 3-7): In one example, the disallowed spaces count contains an unsigned binary integer specifying the number of rightmost bytes of the decimal number in the source which should not contain characters representing spaces. The disallowed spaces count applies, for instance, when the separate sign control and leading sign are zeros. When the disallowed spaces count does apply and is, e.g., 0 or is, e.g., greater than a digits count (described below), results are unpredictable, in one example. Other variations are possible.

Sign test control (STC) 548 (e.g., bits 8-10): In one example, sign test control 548 specifies which codes are considered valid sign codes in the source. When the sign is in a byte having a sign and digit byte format (described below), sign test control values, e.g., 0-7 apply. When the sign is in a byte having the separate sign byte format (described below), sign test control values, e.g., 2-3 apply and other sign test control values are reserved for possible future extensions and should not be specified; otherwise, the program may not operate compatibly in the future. Other variations are possible.

Digits count (DC) 560 (e.g., bits 11-15): In one example, digits count 560 contains an unsigned binary integer specifying the number of bytes in the decimal number which contain a digit. If the digits count field is, e.g., zero, a specification exception is recognized. When the decimal number includes characters representing spaces, the digits count includes the number of spaces. Other variations are possible.

In one example, the values in the separate sign control, leading sign, disallowed spaces count and/or digits count controls specify one of a plurality of data format variations (e.g., zoned format variations) to be used during the test operation. For instance, based on selected settings of the separate sign control (e.g., 0) and the leading sign (e.g., 1), the data format variation (e.g., zoned format variation) is an embedded leading sign type zoned format; based on particular settings of the separate sign control (e.g., 1) and the leading sign (e.g., 0), the data format variation (e.g., zoned format variation) is a separate trailing sign type zoned format; and based on chosen settings of the separate sign control (e.g., 1) and the leading sign (e.g., 1), the data format variation (e.g., zoned format variation) is a separate leading sign type zoned format. Further, as examples, based on defined settings of the separate sign control (e.g., 0) and the leading sign (e.g., 0) and based on the disallowed spaces count having a predetermined relationship with (e.g., equal to) the digits count, the data format variation (e.g., zoned format variation) is an embedded trailing sign type zoned format; and based on defined settings of the separate sign control (e.g., 0) and the leading sign (e.g., 0) and based on the disallowed spaces count having a predefined relationship with (e.g., less than) the digits count, the data format variation (e.g., zoned format variation) is a spaced embedded trailing sign type zoned format. Other examples are possible. For instance, additional, fewer and/or other zoned format variations are possible, additional, fewer and/or other data format variations are possible, and/or other values may be used. Many variations are possible.

Further details regarding examples of zoned format variations are described below:

ETS (embedded trailing sign)-type-zoned format: In one example, the decimal number in the source is tested to comply with this format when, e.g., the separate sign control is, e.g., zero, the leading sign is, e.g., zero, and the value in the disallowed spaces count control, e.g., equals the value in the digits count control. In one example, a decimal number in this format has, for instance, a sign embedded in, e.g., the rightmost byte of the number. The digits count field specifies the number of bytes (or other data units) in the decimal number which contain a digit. In one example, the rightmost byte has the sign and digit byte format (described below). All other bytes have, e.g., the zone and digit byte format (described below). Other variations are possible.

SETS (spaced embedded trailing sign)-type-zoned format: In one example, the decimal number in the source is tested to comply with this format when, e.g., the separate sign control is, e.g., zero, the leading sign is, e.g., zero, and the value in the disallowed spaces control is, e.g., less than the value in the digits count control. In one example, a decimal number in this format has a sign embedded in, e.g., the rightmost byte of the number. The digits count field specifies, for instance, the number of bytes in the decimal number which contain a digit or a space character. In one example, the rightmost byte has the sign and digit byte format. In one example, the value in the disallowed spaces control is subtracted from the value in the digits count control and the difference specifies, e.g., the number of leftmost bytes of the decimal number which may have either the space byte format (described below) or the zone and digit byte format. In one example, the only valid value for a byte having the space byte format is, e.g., 40 hex, which is the EBCDIC (Extended Binary Coded Decimal Interchange Code) code for a space character. Space characters are considered, for instance, nonzero digits. All other bytes have, e.g., the zone and digit byte format. Other variations are possible.

ELS (embedded leading sign)-type-zoned format: In one example, the decimal number in the source is tested to comply with this format when, e.g., the separate sign control is, e.g., zero and the leading sign is, e.g., one. In one example, a decimal number in this format has, for instance, a sign embedded in, e.g., the leftmost byte of the number. The digits count field specifies, for instance, the number of bytes in the decimal number which contain a digit. In one example, the leftmost byte has, e.g., the sign and digit byte format. All other bytes have, for instance, the zone and digit byte format. Other variations are possible.

STS (separate trailing sign)-type-zoned format: In one example, the decimal number in the source is tested to comply with this format when, e.g., the separate sign control is, e.g., one and the leading sign is, e.g., zero. In one example, a decimal number in this format has, for instance, a separate sign in, e.g., the rightmost byte of the number. In one example, the rightmost byte has the separate sign byte format (described below). In one example, the only valid values for a byte having, for instance, the separate sign byte format are, e.g., 4E hex and, e.g., 60 hex, which are the EBCDIC codes for, e.g., positive and negative, respectively. All other bytes have, for instance, the zone and digit byte format. The digits count field specifies, for instance, the number of bytes in the decimal number which contain a digit. The number of bytes in the decimal number is, for instance, one more than the number of bytes containing digits. Other variations are possible.

SLS (separate leading sign)-type-zoned format: In one example, the decimal number in the source is tested to comply with this format when, e.g., the separate sign control is, e.g., one and the leading sign is, e.g., one. In one example, a decimal number in this format has a separate sign in, e.g., the leftmost byte of the number. In one example, the leftmost byte has, for instance, the separate sign byte format. In one example, the only valid values for a byte having, for instance, the separate sign byte format are, e.g., 4E hex and, e.g., 60 hex, which are the EBCDIC codes for, e.g., positive and negative, respectively. All other bytes have, for instance, the zone digit byte format. The digits count field specifies, for instance, the number of bytes in the decimal number which contain a digit. The number of bytes in the decimal number is, e.g., one more than the number of bytes containing digits. Other variations are possible.

In one or more aspects, the source value (e.g., decimal number) includes one or more bytes (or other data units), and each byte may have a byte format. Example types of byte formats include the following:

SD (sign and digit)-byte format: In one example, bytes designated to have this format include, e.g., a sign code (S) in, e.g., the leftmost 4 bits and, e.g., a digit code (D) in, e.g., the rightmost 4 bits. In one example, values A-F hex may be valid sign codes, depending on the specified sign test control (e.g., sign test control 548). In one example, values 0-9 are invalid sign codes. In one example, values 0-9 are valid digit codes. In one example, values A-F hex are invalid digit codes. Other examples are possible.

ZD (zone and digit)-byte format: In one example, bytes designated to have this format include, e.g., a zone code (Z) in, e.g., the leftmost 4 bits and, e.g., a digit code (D) in, e.g., the rightmost 4 bits. If the zone code is, e.g., F hex, then values 0-9 are valid digit codes and values A-F hex are invalid digit codes, as examples. If the zone code is not, e.g., F hex, then any value is considered to be an invalid digit code in the rightmost 4 bits, as an example. Other examples are possible.

SP (space)-byte format: In one example, bytes designated to have this format include, e.g., an 8-bit character considered to represent, e.g., one digit. In one example, value 40 hex, which is the EBCDIC code for a space, is the only valid value for the digit in this byte. All other values in bytes having this format are considered as invalid digits, in one example. Other examples are possible.

SS (separate sign)-byte format: In one example, bytes designated to have this format include, e.g., an 8-bit character representing the sign. In one example, value 4E hex and depending on the sign test control (e.g., sign test control 548), value 60 hex, which are the EBCDIC codes for positive and negative, respectively are valid values to represent the sign. In one example, all other values in a byte having this format are considered to be an invalid sign. Other examples are possible.

During execution of the Vector Test Zoned instruction, in one example, a test is performed of whether the decimal number in the source adheres to a specified variation of the zoned format. The result is indicated in the condition code. Other examples are possible.

In one example, the source is formed from the concatenation of the first operand (e.g., in V₁) followed by the second operand (e.g., in V₂) and contains a source value, such as a decimal value (e.g., decimal number) in a zoned format with a length of, e.g., 1-32 data units (e.g., bytes). The decimal number is right justified in the source. The leftmost bytes of the source which are not part of the decimal number are ignored, in one example.

In accordance with one or more aspects, the decimal number may be in one zoned format of a plurality of zoned formats. In one example of a zoned format, the rightmost four bits of a byte are called the numeric bits and typically include a code representing a decimal digit (D). The leftmost four bits of a byte are called the zone bits (Z), except for the rightmost byte of a decimal operand, where these bits may be treated either as a zone or as a sign (S). Other variations of a zoned format are possible, as described herein. Examples of the variations which may be specified for use during execution of the Vector Test Zoned instruction are provided below:

| Controls | | | | Examples of Decimal #s in the Source | | |
|---|---|---|---|---|---|---|
| SSC | LS | DSC | Specified Variation | DC | DSC | Rightmost 6 bytes of the source |
| 0 | 0 | DSC = DC | ETS-type-zoned | 5 | 5 | // ZD ZD ZD ZD SD |
| 0 | 0 | DSC < DC | SETS-type-zoned | 5 | 3 | // SP SP ZD ZD SD |
| 0 | 0 | DSC < DC | SETS-type-zoned | 5 | 3 | // ZD SP ZD ZD SD |
| 0 | 0 | DSC < DC | SETS-type-zoned | 5 | 3 | // SP ZD ZD ZD SD |
| 0 | 0 | DSC < DC | SETS-type-zoned | 5 | 3 | // ZD ZD ZD ZD SD |
| 0 | 1 | — | ELS-type-zoned | 4 | — | // // SD ZD ZD ZD |
| 1 | 0 | — | STS-type-zoned | 4 | — | // ZD ZD ZD ZD SS |
| 1 | 1 | — | SLS-type-zoned | 4 | — | // SS ZD ZD ZD ZD |

Explanation of the above, as an example:
— Not applicable.
// Source byte contents ignored.
DC Digits count.
DSC Disallowed spaces count.
LS Leading sign.
SD SD (sign and digit)-byte format.
SP SP (space)-byte format.
SS SS (separate sign)-byte format.
SSC Separate sign control.
ZD ZD (zone digit)-byte format.

Other examples and variations are possible.

Example sign code testing for execution of the Vector Test Zoned instruction includes:

| | | All N digits are | Sign codes considered |
|---|---|---|---|
| Source byte format | STC | zeros³ | valid (hex) |
| SD-byte format | 000 | — | A-F¹ |
| SD-byte format | 001 | no | A-F¹ |
| SD-byte format | 001 | yes | A, C, E, F¹ |
| SD-byte format | 010 | — | C, D¹ |
| SD-byte format | 011 | no | C, D¹ |
| SD-byte format | 011 | yes | |
| SD-byte format | 100 | — | F¹ |
| SD-byte format | 101 | — | F¹ |
| SD-byte format | 110 | — | C, D, F¹ |
| SD-byte format | 111 | no | C, D, F¹ |
| SD-byte format | 111 | yes | C, F¹ |
| SS-byte format | 010 | — | 4E, 60² |
| SS-byte format | 011 | no | 4E, 60² |
| SS-byte format | 011 | yes | 4E |

Explanation of the above, as an example:
¹Only the leftmost 4 bits of bytes having this format participate in the sign code testing.
²All 8 bits of bytes having this format participate in the sign code testing.
³Space characters and invalid digits are considered to be nonzero digits.
— Results do not depend on this value.
N The number (N) of digit positions specified by the digits count control to be tested. This number includes characters representing spaces, which are considered to be nonzero digits.

Other examples and variations are possible.

Example digit code testing for execution of the Vector Test Zoned instruction includes:

| Source byte format | Digit codes considered valid (hex) |
|---|---|
| SD-byte format | 0-9¹ |
| ZD-byte format | F0-F9² |
| SP-byte format | 40² |

Other examples and variations are possible.

Example resulting condition codes based on executing the instruction include, for instance:
0 All digit codes and the sign considered valid
1 All digit codes considered valid and sign considered invalid
2 At least one digit code considered invalid and sign considered valid
3 At least one digit code considered invalid and sign considered invalid

Other examples and variations are possible.

Example program exceptions that may occur during execution of the instruction include data with DXC (data exception code) FE, vector instruction; operation (if the vector packed decimal facility for z/Architecture is not installed); transaction constraint. Additional, fewer and/or other program exceptions may occur in other embodiments and/or for other architectures.

In the description herein of a vector test zoned instruction, such as Vector Test Zoned instruction 500, specific locations, specific fields and/or specific sizes of the fields may be indicated (e.g., specific bytes and/or bits). However, other locations, fields and/or sizes may be provided. Further, although the setting of a bit to a particular value, e.g., one or zero, may be specified, this is only an example. The bit, if set, may be set to a different value, such as the opposite value or to another value, in other examples. Many variations are possible.

In one embodiment, the fields of the instruction are separate and independent from one another; however, in other embodiments, more than one field may be combined. Further, although example types of registers are specified for the source fields, other types of registers may be used. For instance, one or more of the source fields, in other embodiments, may specify other than vector registers. Other examples are possible.

A vector test zoned instruction, such as Vector Test Zoned instruction 500, may have additional, fewer and/or other fields. For instance, one or more fields of a vector test zoned instruction, such as Vector Test Zoned instruction 500, may be optional. As an example, RXB field 560 is optional. For instance, a vector test zoned instruction, such as Vector Test Zoned instruction 500, may not have an RXB field. Instead, the one or more source register fields include an indication of the vector register. Many variations are possible.

Although various examples are provided for one or more formats of the instruction, additional and/or other formats may be used. Further, the processing may be used for other purposes than described herein.

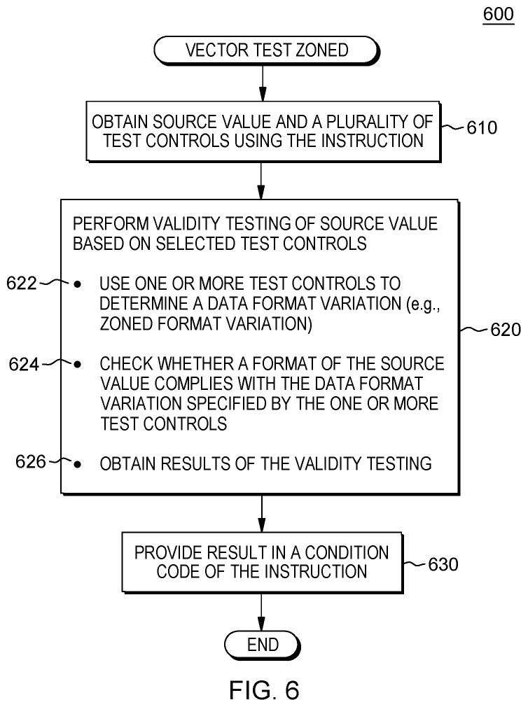

One embodiment of vector test zoned processing using a vector test zoned instruction (e.g., Vector Test Zoned instruction 500) is further described with reference to FIG. 6. In one example, a vector test zoned process 600 is executed by one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g. processor 200) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute the processing and/or aspects thereof. Many examples are possible.

Referring to FIG. 6, in one example, vector test zoned process 600 (also referred to as process 600) obtains 610 a source value and one or more test controls (e.g., a plurality of test controls) using a vector test zoned instruction (e.g., Vector Test Zoned instruction 500). In one example, the source value is obtained from one or more registers (e.g., one or more vector registers) specified using one or more fields of the instruction (e.g., source (V₁) field 520, source (V₂) field 525 and RXB field 560). For instance, the source value is included in a source formed from a concatenation of the value in the register specified by V₁ and the value in the register specified by V₂. The source value is, e.g., a decimal value (e.g., a decimal number) in one zoned format of a plurality of zoned formats.

Further, in one example, the plurality of test controls is obtained from the control field (e.g., immediate field, I₃) of the instruction. The plurality of test controls includes, for instance, separate sign control 542, leading sign 544, disallowed spaces count 546, sign test control 548 and digits count 550. In other embodiments, additional, fewer and/or other test controls may be obtained, one or more of which may be used in the vector test zoned processing.

Based on obtaining the source value and the plurality of test controls, in one embodiment, process 600 performs 620 validity testing of the source value based on one or more of the test controls (e.g., selected test controls). For instance, process 600 determines whether a format of at least a portion of the source value adheres to a zoned format variation specified using, at least, one or more of the test controls.

In one example, the perform validity testing includes using 622, at least, one or more of the test controls to determine a data format variation (e.g., a zoned format variation) to which the source value (e.g., a format of at least a portion of the source value) is to adhere. For instance, based on separate sign control 542 being a selected value (e.g., 0) and the leading sign 544 being another selected value (e.g., 1), the zoned format variation is an embedded leading sign (ELS) type zoned format. Process 600 checks 624 whether the format of the at least a portion of the source value complies to the embedded leading sign type zoned format and obtains 626 a result of the validity testing. Other examples of formats and tests are described herein.

Process 600 provides 630 the result as an output of executing the instruction. In one example, the result is returned as a condition code of the instruction.

Described above is a vector test zoned instruction configured to specify a plurality of zoned format variations using test controls of the instruction. The test controls are used to perform validity testing of a source value (e.g., a decimal value in a zoned format). The validity testing determines whether a format of the source value (e.g., the zoned format of the source value) adheres to the zoned format variation specified using one or more test controls of the instruction. In one or more aspects, a single architected instruction is used that enables various data correctness criteria (e.g., various digit/sign tests based on the zoned format variation specified by the test controls) for the zoned data format to be specified and/or tested at the same time (e.g., in a single clock cycle or in fewer clock cycles than previous compare/branch code sections).

In one or more aspects, customers/users use different versions of the zoned data format, such as the sign information can be leading or trailing the data; the sign digit can be embedded with the last data digit or separate; valid sign digits are varying; at times, parts of the data are not allowed to contain space characters, etc. One or more (even all) of these scenarios may be tested at the same time in, e.g., a single clock cycle or in fewer clock cycles than previous compare/branch code sections using a single architected instruction (e.g., vector test zoned).

Use of the instruction improves (e.g., speeds-up) compiler (e.g., COBOL compiler) migration and currency and enables applications compiled by the compiler (e.g., COBOL applications) to adopt new architectural features, by providing a faster mechanism to enforce data validity and avoid unpredictable behavior in production.

In certain computer programming languages, such as COBOL, not all bit encodings are valid and therefore, the instruction provided herein (e.g., Vector Test Zoned instruction) is used to identify if the given data (e.g., source value, such as a zoned decimal) is valid. The determination of validity is based on one or more test controls provided by the instruction. This provides flexibility, robustness and effectiveness for the computer application. By using an architected instruction, testing overhead is reduced, allowing wide usage of the data validity checking, including in production environments. The architected instruction replaces long checking code previously provided within an application with fewer instructions (e.g., one architected instruction).

Previously, to help identify invalid data cases (e.g., invalid data format cases) at runtime, a compiler (e.g., COBOL compiler) option has been used on zoned data. This option checks data at runtime by cutting out parts of a bitstring that are to be checked, comparing them against valid bitstrings and displaying a message (that is optionally terminating) about the location(s) of the invalid data so it can be fixed. This takes many instructions and branches, slowing down processing. Thus, it is typically not used in a production environment. Therefore, in accordance with one or more aspects of the present disclosure, an instruction is provided (e.g., Vector Test Zoned) that is able to selectively test for different zoned data formats and to perform various digit/sign tests of the selected zoned data format at the same time (e.g., in a single clock cycle or in fewer cycles than the previous compiler option).

For instance, the compiler option may include code to perform checks, such as the code below:

| | | |
|---|---|---|
| CLC | 0(5,R4), 484(R3) | −> check for negative 0 |
| JE | L0322 | −> jump |
| XR | R2,R2 | |
| TRT | 0(5,R4), 0(R6) | −> F0-F9 : 00, C0-C9, D0-D9 : 0x80, else : 0x10 |
| BRC | 13, L_AbendMsg | −> found some digits besides F0-F9, C0-C9, D0-D9 |
| NILF | R2,X’00000007F’ | −> check that last digit is 0x80 (C0-C9, D0-D9) |

However, in accordance with one or more aspects, the above code may be replaced by, for instance:

| | |
|---|---|
| VLRL V16,0(R4),4 | −> load 5-byte value to be tested into a vector register |
| VTZ V15,V16 0x0565 | −> SSC=0,LS=0,DSC=00101,STC=011,DC=00101 (all |
| | binary encodings) |
| BRC 7,L_AbendMsg | −> branch to code to produce a message and/or abend on |
| | invalid data |

In the replacement code sequence, a single instruction, (e.g. Vector Test Zoned (VTZ)), replaces multiple instructions above (e.g., CLC, XR, TRT, NILF) and at least one branch (BRC).

In one or more aspects, the instruction (e.g., Vector Test Zoned) is placed at one or more locations in a computer application, which checks during runtime, the validity of data (e.g., data format validity of the data) used in the computer application. The data to be checked is input to the instruction as a source value. The instruction performs the validity testing, as provided by the test controls of the instruction, to obtain a result. The result is provided in a condition code of the instruction. The condition code may be checked by other code of the computer application prior to performing processing using the data, e.g., one or more arithmetic computations, move to another data item, pass to another program, use in a compare operation, etc. For instance, if the condition code indicates that the data is valid, then the data is used in further processing within the computer application. Other use cases are also possible.

In one example, the condition code states whether the source value is a valid zoned format variation. This is based on testing a format of the source operand based on one or more of the test controls (e.g., separate sign control, leading sign, disallowed space count, and/or others) specified in a control field of the instruction.

Other variations and embodiments are possible.

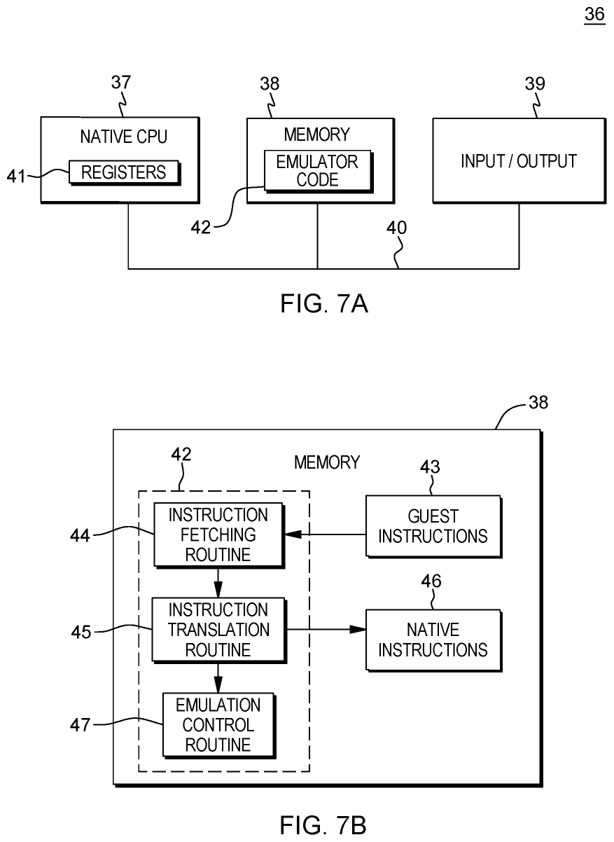

Further, although one or more examples of a computing environment to incorporate and use one or more aspects of the present disclosure are described herein, FIGS. 7A-7B depict another embodiment of a computing environment to incorporate and use one or more aspects of the present disclosure.

Referring, initially, to FIG. 7A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 7B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native CPU 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native CPU 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native CPU or by using locations in memory 38. In embodiments, guest instructions 43, native instructions 46 and emulator code 42 may reside in the same memory or may be disbursed among different memory devices.

An example instruction that may be emulated is the Vector Test Zoned instruction described herein, in accordance with one or more aspects of the present disclosure.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to implement validity testing, vector test zoned processing and/or to perform one or more other aspects of the present disclosure.

One or more aspects of the present disclosure are tied to computer technology and facilitate processing within a computer, improving performance thereof. For instance, processing speed is increased, and error processing and latency, as well as costs, are reduced. Processing within a processor, computer system and/or computing environment is improved.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

Yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other instruction formats, operands and/or registers may be used. Further, the data units may be other than bytes. Moreover, additional, fewer and/or other zone format variations and/or byte format variations may be used. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
a set of one or more computer readable storage media; and
program instructions, collectively stored in the set of one or more computer readable storage media, for causing at least one computing device to perform the following computer operations including:
executing an instruction to perform validity testing of a source value, the executing the instruction including:
obtaining the source value using at least one field of the instruction;
performing validity testing of at least a portion of the source value based on one or more test controls obtained using a field of the instruction, wherein the performing the validity testing determines whether a format of the at least the portion of the source value adheres to a data format variation specified by, at least, the one or more test controls, and wherein the performing the validity testing provides a result; and
providing the result for use in further processing.

2. The computer program product of claim 1, wherein the providing the result includes including the result in a condition code returned at completion of executing the instruction.

3. The computer program product of claim 1, wherein the source value is a decimal value in a zoned format and the data format variation is a zoned format variation.

4. The computer program product of claim 1, wherein the source value includes a plurality of data units, and the one or more test controls include:
a separate sign control specifying whether the source value is to include a sign in a data unit of the plurality of data units separate from other data units of the plurality of data units that include digits; and
a leading sign specifying a particular data unit of the plurality of data units of the source value to include a sign of the source value,
and wherein the performing the validity testing includes:
using the separate sign control and the leading sign to determine the data format variation for which the format of the at least the portion of the source value is to adhere; and
checking that the format of the at least the portion of the source value complies to the data format variation.

5. The computer program product of claim 4, wherein based on selected settings of the separate sign control and the leading sign, the data format variation is an embedded leading sign type zoned format.

6. The computer program product of claim 4, wherein based on particular settings of the separate sign control and the leading sign, the data format variation is a separate trailing sign type zoned format.

7. The computer program product of claim 4, wherein based on chosen settings of the separate sign control and the leading sign, the data format variation is a separate leading sign type zoned format.

8. The computer program product of claim 4, wherein the one or more test controls further include a disallowed spaces count specifying a number of selected data units of the plurality of data units of the source value not to contain characters representing spaces, and wherein the performing the validity testing includes using the separate sign control, the leading sign and the disallowed spaces count to determine the data format variation for which the format of the at least the portion of the source value is to adhere.

9. The computer program product of claim 8, wherein the one or more test controls further include a digits count specifying a number of data units of the plurality of data units of the source value to contain a digit, and wherein the performing the validity testing includes using the separate sign control, the leading sign, the disallowed spaces count and the digits count to determine the data format variation for which the format of the at least the portion of the source value is to adhere.

10. The computer program product of claim 9, wherein based on defined settings of the separate sign control and the leading sign and based on the disallowed spaces count having a predetermined relationship with the digits count, the data format variation is an embedded trailing sign type zoned format.

11. The computer program product of claim 9, wherein based on defined settings of the separate sign control and the leading sign and based on the disallowed spaces count having a predefined relationship with the digits count, the data format variation is a spaced embedded trailing sign type zoned format.

12. The computer program product of claim 1, wherein the source value includes a plurality of data units, and wherein the data format variation specifies one or more data unit formats for at least a set of data units of the plurality of data units, the one or more data unit formats being of a plurality of data unit formats.

13. The computer program product of claim 12, wherein the plurality of data units is a plurality of bytes, and wherein the plurality of data unit formats includes a sign and digit byte format, a zone and digit byte format, a space byte format, and a separate sign byte format.

14. A computer system for facilitating processing within a computing environment, the computer system comprising:
at least one computing device;
a set of one or more computer readable storage media; and
program instructions, collectively stored in the set of one or more computer readable storage media, for causing the at least one computing device to perform the following computer operations including:
executing an instruction to perform validity testing of a source value, the executing the instruction including:
obtaining the source value using at least one field of the instruction;
performing validity testing of at least a portion of the source value based on one or more test controls obtained using a field of the instruction, wherein the performing the validity testing determines whether a format of the at least the portion of the source value adheres to a data format variation specified by, at least, the one or more test controls, and wherein the performing the validity testing provides a result; and
providing the result for use in further processing.

15. The computer system of claim 14, wherein the source value is a decimal value in a zoned format and the data format variation is a zoned format variation.

16. The computer system of claim 14, wherein the source value includes a plurality of data units, and the one or more test controls include:
a separate sign control specifying whether the source value is to include a sign in a data unit of the plurality of data units separate from other data units of the plurality of data units that include digits; and
a leading sign specifying a particular data unit of the plurality of data units of the source value to include a sign of the source value,
and wherein the performing the validity testing includes:
using the separate sign control and the leading sign to determine the data format variation for which the format of the at least the portion of the source value is to adhere; and
checking that the format of the at least the portion of the source value complies to the data format variation.

17. The computer system of claim 16, wherein the one or more test controls further include a disallowed spaces count specifying a number of selected data units of the plurality of data units of the source value not to contain characters representing spaces, and wherein the performing the validity testing includes using the separate sign control, the leading sign and the disallowed spaces count to determine the data format variation for which the format of the at least the portion of the source value is to adhere.

18. The computer system of claim 17, wherein the one or more test controls further include a digits count specifying a number of data units of the plurality of data units of the source value to contain a digit, and wherein the performing the validity testing includes using the separate sign control, the leading sign, the disallowed spaces count and the digits count to determine the data format variation for which the format of the at least the portion of the source value is to adhere.

19. A computer-implemented method of facilitating processing within a computing environment, the computer-implemented method comprising:
executing an instruction to perform validity testing of a source value, the executing the instruction including:
obtaining the source value using at least one field of the instruction;
performing validity testing of at least a portion of the source value based on one or more test controls obtained using a field of the instruction, wherein the performing the validity testing determines whether a format of the at least the portion of the source value adheres to a data format variation specified by, at least, the one or more test controls, and wherein the performing the validity testing provides a result; and
providing the result for use in further processing.

20. The computer-implemented method of claim 19, wherein the source value is a decimal value in a zoned format and the data format variation is a zoned format variation.

21. The computer-implemented method of claim 19, wherein the source value includes a plurality of data units, and the one or more test controls include:
a separate sign control specifying whether the source value is to include a sign in a data unit of the plurality of data units separate from other data units of the plurality of data units that include digits; and
a leading sign specifying a particular data unit of the plurality of data units of the source value to include a sign of the source value,
and wherein the performing the validity testing includes:
using the separate sign control and the leading sign to determine the data format variation for which the format of the at least the portion of the source value is to adhere; and
checking that the format of the at least the portion of the source value complies to the data format variation.

22. The computer-implemented method of claim 21, wherein the one or more test controls further include a disallowed spaces count specifying a number of selected data units of the plurality of data units of the source value not to contain characters representing spaces, and wherein the performing the validity testing includes using the separate sign control, the leading sign and the disallowed spaces count to determine the data format variation for which the format of the at least the portion of the source value is to adhere.

23. The computer-implemented method of claim 22, wherein the one or more test controls further include a digits count specifying a number of data units of the plurality of data units of the source value to contain a digit, and wherein the performing the validity testing includes using the separate sign control, the leading sign, the disallowed spaces count and the digits count to determine the data format variation for which the format of the at least the portion of the source value is to adhere.

24. A computer program product for facilitating processing within a computing environment, the computer program product comprising:
a set of one or more computer readable storage media; and
program instructions, collectively stored in the set of one or more computer readable storage media, for causing at least one computing device to perform computer operations including:
executing an instruction to perform validity testing of a source value, the executing the instruction including:
performing validity testing of at least a portion of the source value based on a plurality of test controls obtained using a field of the instruction, the performing the validity testing comprising:
determining that a format of the at least the portion of the source value adheres to a data format variation specified by, at least, one or more test controls of the plurality of test controls; and
ascertaining, using at least one test control of the plurality of test controls, that one or more digits and a sign code of the at least the portion of the source value are valid; and
providing a result of the validity testing for use in further processing.

25. A computer program product for facilitating processing within a computing environment, the computer program product comprising:
a set of one or more computer readable storage media; and
program instructions, collectively stored in the set of one or more computer readable storage media, for causing at least one computing device to perform computer operations including:
executing an instruction to perform validity testing of a decimal number in a zoned format, the executing the instruction including:
performing validity testing of the decimal number based on a plurality of test controls obtained using a field of the instruction, the performing the validity testing comprising:
determining that a format of the decimal number adheres to a zoned format variation specified by, at least, one or more test controls of the plurality of test controls; and
ascertaining, using at least one test control of the plurality of test controls, that one or more digits and a sign code of the decimal number are valid; and
providing a result of the validity testing in a condition code of the instruction for use in further processing.
